(19) United States
(12) Patent Application Publication
(10) Pub. No.: US 2003/0221688 A1
(43) Pub. Date: Dec. 4, 2003

(54) Method and apparatus for curing colds

(76) Inventor: Jim Carey, Anchorage, AK (US)

Correspondence Address: Howard B. Rockman, Lee, Mann, Smith, McWilliams, Sweeney & Ohlson, P.O. Box 2786, Chicago, IL, 60690-2786, US

(21) Appl. No.: 10/157,052

(22) Filed: May 29, 2002

(51) Int. Cl. A62B 7/00

(52) U.S. Cl. 128/200.24

(57) ABSTRACT

A method and apparatus for the treatment of colds. The method comprises directing heated air into the mouth of a human being, which is then held in the lungs for a period of time. The heated air is then exhaled from the lungs through either the mouth or the nose. A heat generator is provided for direction of the heated air into the body. Prior to entering the body, the heated air passes through a cone-shaped device. The temperature of the air is incrementally increased as the method is repeated. The heated air in the body kills cold sustaining bacteria.

### BACKGROUND OF THE INVENTION

This invention concerns the ability to cure colds in human beings. Specifically, this invention is concerned with killing germs that reside in the mouth, lungs, and nasal passages of human beings.

The common cold affects millions of people every year. It is annoying, and at present there is no known cure. The pharmaceutical industry continues to produce and market medications for treating colds that simply ease the symptoms of the cold and do not attack the root of the cold. This invention is aimed at killing the cold-causing bacteria that reside in the respiratory systems of human beings.

Upon directing hot air into the mouth of an individual who suffers from cold symptoms, the hot air attacks the bacteria that resides in the respiratory system, including the nasal passages and the lungs. By attacking the bacteria, the cold is being attacked at it source. If the user begins practicing the methods as described by this invention when the user first begins to experience cold symptoms, the life of the cold will be dramatically shortened.

### SUMMARY OF THE INVENTION

The present invention provides a method of applying heat through the mouth to internal organs of the body for the treatment of colds. Heated air is applied under pressure into the mouth and inhaled into the body. The heated air is then exhaled from the body. The air is incrementally increased in temperature before it is applied into the mouth.

The invention provides a further method for applying heat through the mouth to internal organs such as the lungs for the treatment of colds. The heated air that is applied into the mouth under pressure and inhaled into the body is then held in the body for a period of time before the air is exhaled from the body. The air is incrementally increased in temperature before it is applied into the mouth. The air is held in the body for a period in the range of 3-6 seconds. The air is then exhaled out of the body for a period in the range of 3-6 seconds.

The invention further provides a method for treating colds using heated air applied to the internal organs, where a cone-shaped device is either removably secured to a user's hand, or it is held in the user's hand.

The invention further provides an apparatus for applying heat to internal organs of the body to kill bacteria that cause colds. The apparatus includes a heat generator having a passage for the movement of air across the heat generator, a fan or like device to move the air across the heat generator and out of an exit port in the apparatus, and a cone-shaped device removably attached to the apparatus over the exit port of the apparatus. The cone-shaped device may be attached to the heat generator using an elastic band, or the cone-shaped device is removably attached to the heat generator using fasteners. The cone-shaped device is also adapted to be hand held. Finally, the heat generator may be removably fastened to a support structure.

### BRIEF DESCRIPTION OF THE DRAWINGS

The invention is described in greater detail in the following description of examples embodying the best mode of the invention, taken in conjunction with the drawing figures, in which:

FIG. 1 is a side sectional view of a heat generator in a mounting bracket according to the invention;

FIG. 2 is a side perspective view of a cone-shaped device and elastic band attachment according to the invention;

FIG. 3 is a side sectional view of a heat generator and filter adapted for hand held use according to the invention;

FIGS. 4 and 4A are side views of one method for treating colds according to the present invention;

FIGS. 5 and 5A are side views of an alternate method for curing colds according to this invention;

FIGS. 6 and 6A are side views of an alternate method for curing colds according to this invention; and

FIGS. 7 and 7A are side views of an alternate method for curing colds according to this invention.

### DESCRIPTION OF EXAMPLES EMBODYING THE BEST MODE OF THE INVENTION

For the purpose of promoting an understanding of the principles of the invention, references will be made to the embodiments illustrated in the drawings. It will, nevertheless, be understood that no limitation of the scope of the invention is thereby intended, such alterations and further modifications in the illustrated device, and such further applications of the principles of the invention illustrated herein being contemplated as would normally occur to the one skilled in the art to which the invention relates.

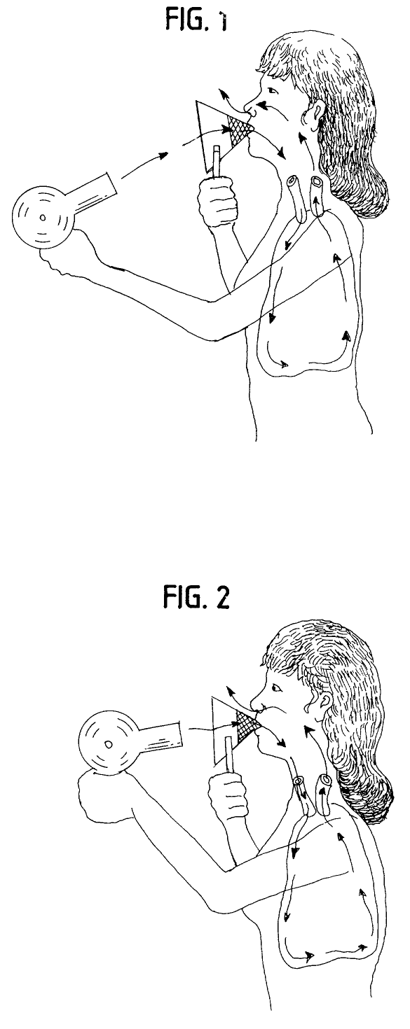

The invention encompasses both an apparatus and a method for the treatment of colds. One form of the apparatus for treatment of colds comprises a heat generator 10, as shown in FIG. 1, and a cone-shaped device 12, as shown in FIG. 2. The heat generator 10 is similar to a conventional hair dryer, and is comprised of heating coils 14, a fan 16 for delivering air over the heating coils 14 producing heated air under pressure in a passage 18 through which the heated air travels through and out of the heat generator, an incremented or variable temperature control 20, and a power cord 22. The fan 16 in the heat generator 10 is activated when the power cord 22 is plugged into an electrical source, and a switch (not shown) is activated to drive the fan 16. The fan 16 circulates air over the heating coils 14 and through the passage 18. The heating coils 14 are controlled by the temperature control 20. As the temperature control 20 is set to a higher level, the heating coils 14 become hotter. Likewise, as the temperature control 20 is set to a lower level the heating coils 14 produce less heat.

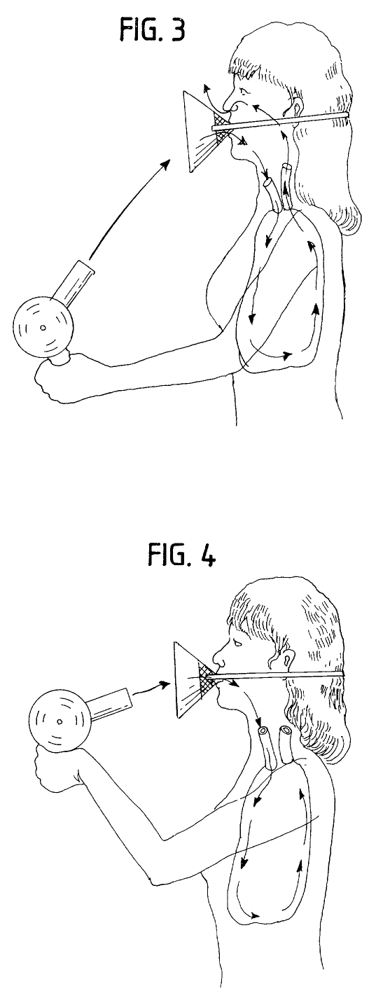

The cone-shaped device 12 is made of cotton, plastic, or any conventional material suitable for air filtration. The cone-shaped device 12 insulates the user's 32 lips from the temperatures of the heat generator 10. The cone-shaped device 12 may be removably attached to the heat generator 10, as shown in FIGS. 4. 4a. In one embodiment of the invention (FIG. 2), the cone-shaped device 12 is removably attached to the heat generator 10 by way of an elastic band 24. A clip 26 is secured to the cone-shaped device 12 and serves as a connector for the elastic band 24. Any other suitable fasteners may be used to secure the cone-shaped device 12 to the heat generator 10 or to a user, as shown in FIGS. 6, 6a. In a further embodiment of the invention, the cone-shaped device 12 is adapted to be hand held by attaching the cone-shaped device 12 to a handle 30, as shown in FIG. 3.

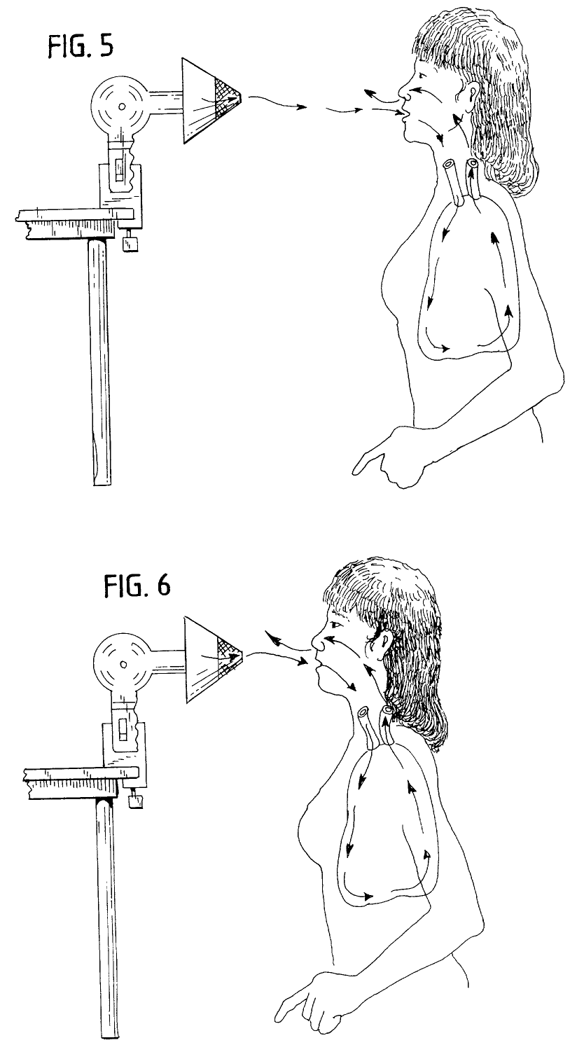

The invention further includes at least four methods, as shown in FIGS. 5 through 7A, for use of the apparatus for the treatment of colds. In the first method, as shown in FIGS. 4 and 4A, the cone-shaped device 12 is removably attached to the exit of passage 18 of heat generator 10. To apply heat to the cold breeding germs, the user 32 holds the heat generator 10 in one hand, and lifts the heat generator 10 with the attached cone-shaped device 12 to the user's mouth 34, as shown in FIG. 4A. The cone-shaped device 12 directs heated air, created by the heat generator 10, through the user's mouth 32 and throat and into the user's lungs 36. The user 32 then holds the air in the lungs 36 for a period of time in the range of 3-6 seconds. After the air is held in the lungs 36 for a period of time, the user 32 begins a paced exhale of the air through the user's nose 38. The air should be exhaled for a period of time in the range of 3-6 seconds. In an alternate embodiment of this method, the user 32 exhales the air out of the lungs 36 through the mouth 34. The air is also exhaled for a period of time in the range of 3-6 seconds. Throughout this first method, the user 32 is either seated, kneeling, or standing. The heated air contacts the bacteria in the mouth, throat, lungs and nose of the user, and kills the bacteria.

In a second method of the present invention, as shown in FIGS. 5 and 5A, the cone-shaped device 12 is adapted to be hand held and is secured to a handle 30. The user 32 holds the handle 30, which supports the cone-shaped device 12, in one hand, and holds the heat generator 10 in the other hand. The cone-shaped device 12 is raised to a position in front of the user's mouth 34, and the heat generator 10 is raised to meet the cone-shaped device 12 near the user's mouth 34, as shown in FIGS. 5 and 5A. In this method, the heated air is transferred from the passage 18 of the heat generator 10 through the cone-shaped device 12 and into the user's mouth 34, throat and lungs 36. The user 32 inhales the heated air for a period of time in the range of 3-6 seconds. After the user 32 stops inhaling, the user 32 holds the heated air in the lungs 36 for a period of time in the range of 3-6 seconds. The user 32 then begins a systematic exhalation of the heated air from the lungs 36. The exhalation is for a period of time in the range of 3-6 seconds. The air is exhaled either through the user's mouth 34 or nose 38. Throughout this method, the user 32 is either seated, kneeling, or standing.

In a third method of the present invention, as shown in FIGS. 6 and 6A, the cone-shaped device 12 is adapted to fit around the user's head and is secured to the head via elastic band 24. The user 32 holds the heat generator 10 in either hand. Once the heat generator 10 is activated, it is raised to meet the cone-shaped device 12 near the user's mouth 34, as shown in FIG. 6A. The heated air is transferred from the heat generator 10 through the cone-shaped device 12 into the user's mouth 34, throat and lungs 36. The user 32 inhales the heated air for a period of time in the range of 3-6 seconds. After the user 32 stops inhaling, the user 32 holds the heated air in the lungs 36 for a period of time in the range of 3-6 seconds. The user 32 then begins a systematic exhalation of the heated air from the lungs 36 for a period of time in the range of 3-6 seconds. The air is exhaled either through the user's mouth 34 or nose 38. Throughout this method, the user 32 is either seated, kneeling, or standing.

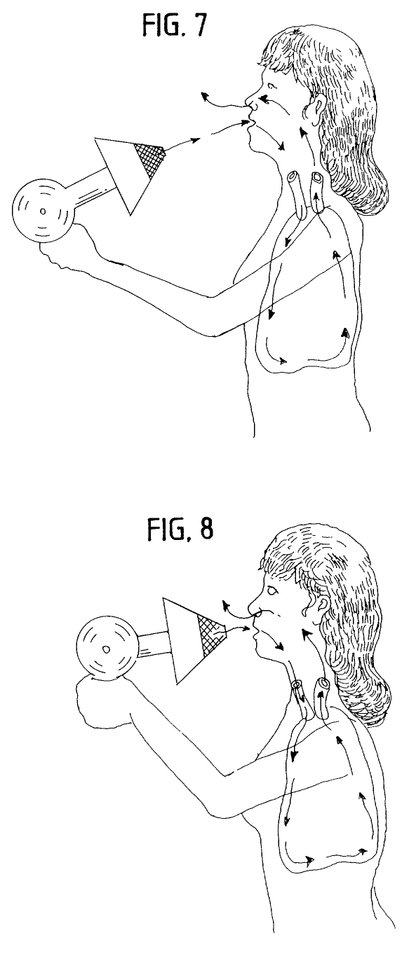

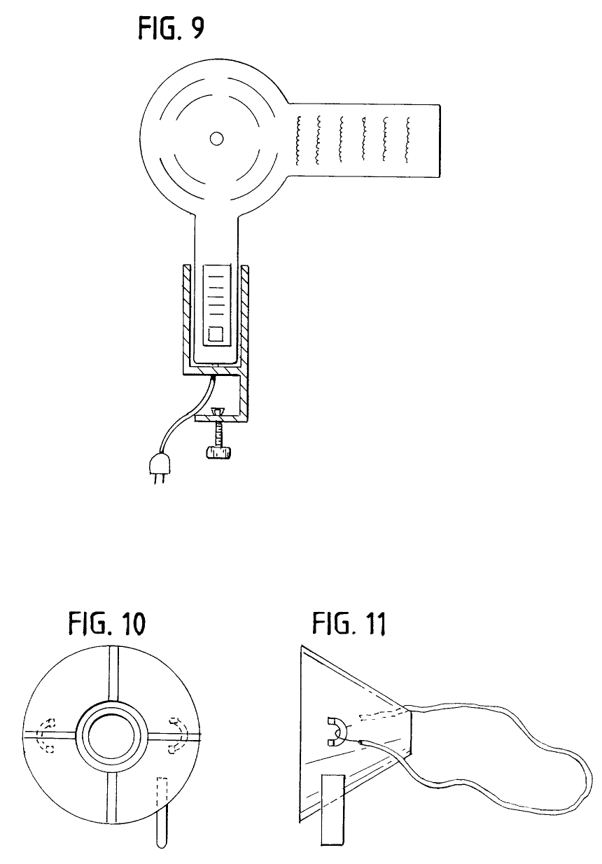

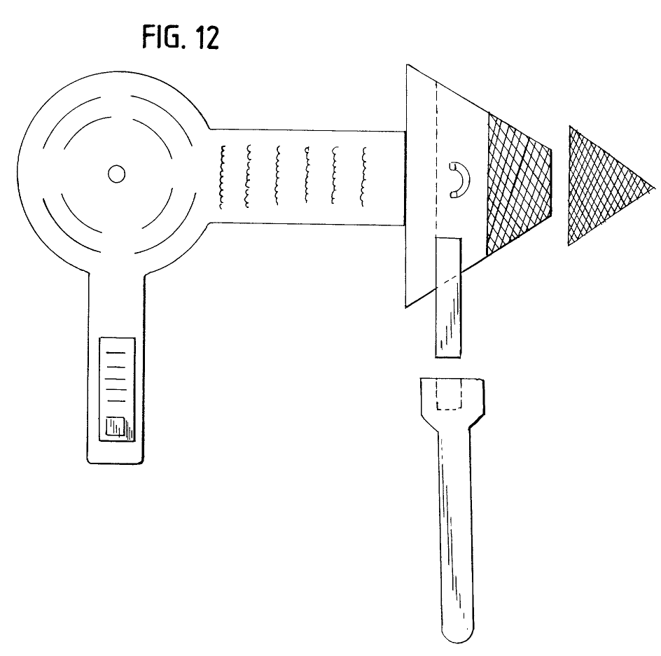

In a fourth method according to the present invention, as shown in FIGS. 7 and 7A, the heat generator 10 is held in a support structure 28, which is removably attached to a table 40, such as by the screw tightening device 41. The cone-shaped device 12 is removably attached to the heat exit end of passage 18 of generator 10. In this method, unlike the other methods, the heat generator 10 is stationary and the user 32 moves towards and away from the best generator. Once the heat generator 10 is activated, the user 32 moves his/her mouth 34 so that it is adjacent the cone-shaped device 12, as shown in FIG. 7A. The heated air is transferred from the heat generator 10 through the cone-shaped device 12 into the user's mouth 34, throat and lungs 36. The user 32 inhales the heated air for a period of time in the range of 3-6 seconds. After the user 32 stops inhaling, the user 32 holds the heated air in the lungs 36 for a period of time in the range of 3-6 seconds. The user 32 then begins a systematic exhalation of the heated air from the lungs 36 for a period of time in the range of 3-6 seconds. The air is exhaled either through the user's mouth 34 or nose 38. The user 32 is preferably seated in this method, however, it is envisioned that the user 32 may also stand or kneel.

With each of the methods described in this invention, the user 32 should periodically drink water to prevent excessive dryness of the mouth 34, lips and throat.

Various features of the invention have been particularly shown and described in connection with the illustrated embodiments of the invention. However, it must be understood that these particular products, and their method of manufacture, do not limit but merely illustrate, and that the invention is to be given its fullest interpretation within the terms of the appended claims.

I claim:

1. A method for applying heat through the mouth to internal organs of the body for the treatment of colds, comprising the steps of:
a. applying heated air under pressure at a first temperature into the mouth;
b. inhaling the heated air into the body; and
c. exhaling the heated air out of the body.

2. The method of claim 1 including repeating steps a, b and c and incrementally increasing the temperature of the heated air prior to applying the heated air under pressure into the mouth for each repetition.

3. The method of claim 1 including the additional step of directing the heated air prior to inhaling the heated air into the body.

4. The method of claim 1 wherein the heated air is exhaled through the nose.

5. A method for applying heat through the mouth to internal organs of the body for the treatment of colds, comprising the steps of:
a. applying heated air under pressure into the mouth;
b. inhaling the heated air into the body;
c. holding the heated air in the body for a period of time; and
d. exhaling the heated air out of the body.

6. The method of claim 5 including repeating steps a, b, c and d, and incrementally increasing the temperature of the heated air prior to applying the heated air under pressure into the mouth for each repetition.

7. The method of claim 5 including the additional step of directing the heated air prior to inhaling the heated air into the body.

8. The method of claim 5 wherein the heated air is exhaled through the nose.

9. The method of claim 5, wherein the heated air is held in the body for a period in the range of 3-6 seconds.

10. The method of claim 5 wherein the heated air is exhaled out of the body for a period in the range of 3-6 seconds.

11. A method for treating colds using heated air applied to the lungs of a person, comprising the steps of:
a. directing heated air into the lungs;
b. holding the heated air in the lungs for a period of time; and
c. exhaling the heated air out of the lungs.

12. The method of claim 11, wherein the heated air is directing prior to being directed into the lungs.

13. The method of claim 11, including repeating steps a, b and c, and incrementally increasing the temperature of the heated air prior to directing the heated air into the lungs for each repetition.

14. The method of claim 11, wherein the heated air is exhaled through the nose.

15. The method of claim 11, wherein the heated air is held in the lungs for a period in the range of 3-6 seconds.

16. The method of claim 11, wherein the heated air is exhaled for a period in the range of 3-6 seconds.

17. The method of claim 12, wherein a cone-shaped device is removably secured to a user's head and the heated air passes through the cone-shaped device prior to being applied to the lungs.

18. The method of claim 12, wherein a cone-shaped device is held in a user's hand and the heated air passes through the cone-shaped device prior to being applied to the lungs.

19. An apparatus for applying heat to internal organs of the body to cure colds, comprising:
a. a heat generator having a passage for the movement of air across a heat generating element;
b. an air driver to move the air across the heat generator and out of an exit port of the passage; and
c. a cone-shaped device removably attached to the apparatus over the exit port of the apparatus.

20. The apparatus of claim 19, wherein the cone-shaped device is removably attached to the heat generator using an elastic band.

21. The apparatus of claim 19, wherein the cone-shaped device is removably attached to the heat generator using fasteners.

22. The apparatus of claim 19, wherein the cone-shaped device is attached to a handle, the filter adapted to be hand held.

23. The apparatus of claim 19, wherein the heat generator is removably fastened to a support structure.
